(19) United States
(12) Patent Application Publication
(10) Pub. No.: US 2025/0106857 A1
(43) Pub. Date: Mar. 27, 2025

(54) REDUCED COMPLEXITY PHYSICAL DOWNLINK CONTROL CHANNEL DECODING

(71) Applicant: QUALCOMM Incorporated, San Diego, CA (US)

(72) Inventors: Jian LI, Shanghai (CN); Liangming WU, Beijing (CN); Changlong XU, Beijing (CN); Jing JIANG, San Diego, CA (US); Kangqi LIU, San Diego, CA (US); Wei YANG, San Diego, CA (US); Hobin KIM, San Diego, CA (US); Hari SANKAR, San Diego, CA (US); Hao XU, Beijing (CN)

(21) Appl. No.: 18/730,885

(22) PCT Filed: Mar. 25, 2022
(86) PCT No.: PCT/CN2022/082937

§ 371 Date: Jul. 22, 2024

(51) Int. Cl. H04W 72/23; H04L 27/26

(52) U.S. Cl. CPC H04W 72/23; H04L 27/261

(57) ABSTRACT

Wireless communications systems and methods related to communicating control information are provided. A method of wireless communication performed by a user equipment (UE) may include monitoring a first set of physical downlink control channel (PDCCH) candidate resources for a PDCCH communication from a network unit, receiving, from the network unit, a plurality of demodulation reference signals (DMRSs), and decoding, based on a metric associated with the plurality of demodulation reference signals (DMRSs) satisfying a threshold, the PDCCH communication.

### TECHNICAL FIELD

This application relates to wireless communication systems, and more particularly, to reduced complexity physical downlink control channel (PDCCH) decoding.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE), may include monitoring a first set of physical downlink control channel (PDCCH) candidate resources for a PDCCH communication from a network unit, receiving, from the network unit, a plurality of demodulation reference signals (DMRSs), and decoding, based on a metric associated with the plurality of demodulation reference signals (DMRSs) satisfying a threshold, the PDCCH communication.

In an additional aspect of the disclosure, a method of wireless communication performed by a network unit may include transmitting an indication of a set of physical downlink control channel (PDCCH) candidate resources, transmitting a plurality of demodulation reference signals (DMRSs), and receiving, based on a metric associated with the plurality of DMRSs, a communication.

In an additional aspect of the disclosure, a user equipment (UE) may include a memory; a transceiver; and at least one processor coupled to the memory and the transceiver, wherein the UE is configured to monitor a first set of physical downlink control channel (PDCCH) candidate resources for a PDCCH communication from a network unit, receive, from the network unit, a plurality of demodulation reference signals (DMRSs), and decode, based on a metric associated with the plurality of demodulation reference signals (DMRSs) satisfying a threshold, the PDCCH communication.

In an additional aspect of the disclosure, an apparatus for wireless communications may include a processor; memory coupled with the processor; and instructions stored in the memory and executable by the processor to cause the apparatus to transmit an indication of a set of physical downlink control channel (PDCCH) candidate resources, transmit a plurality of demodulation reference signals (DMRSs), and receive, based on a metric associated with the plurality of DMRSs, a communication.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure

FIG. 3 illustrates resources associated with a PDCCH communication according to some aspects of the present disclosure.

FIG. 4 is a flow diagram of a wireless communication method according to some aspects of the present disclosure.

FIG. 5 is a signaling diagram of a wireless communication method according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

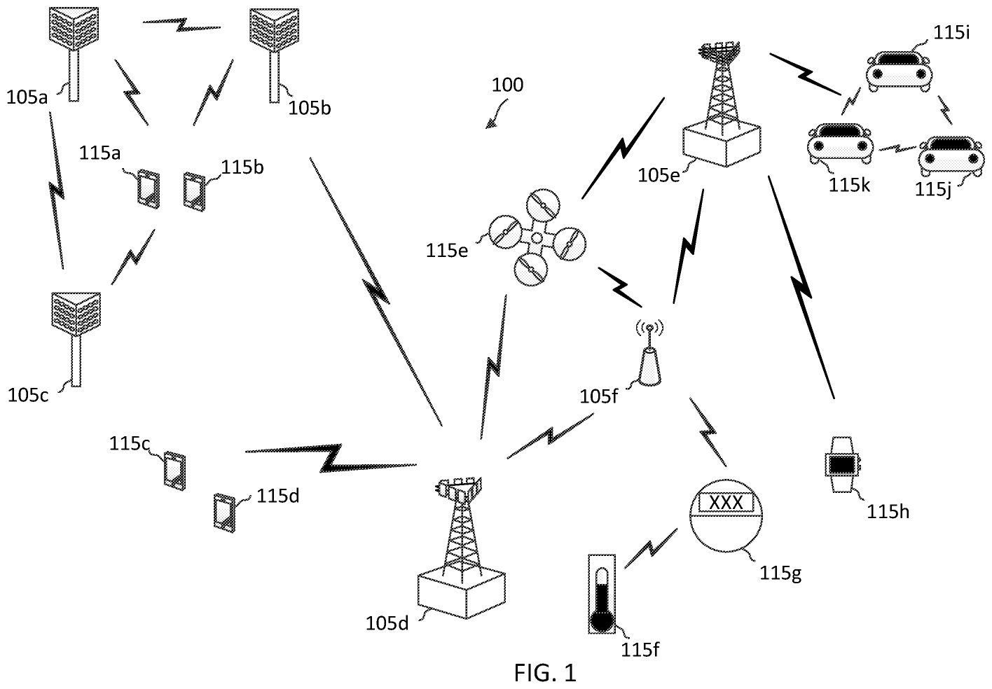

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, a method of wireless communication may be performed by the UE 115. The method may include monitoring a first set of physical downlink control channel (PDCCH) candidate resources for a PDCCH communication from the BS 105, receiving, from the BS 105, a plurality of demodulation reference signals (DMRSs) and decoding, based on a metric associated with the plurality of demodulation reference signals (DMRSs) satisfying a threshold, the PDCCH communication.

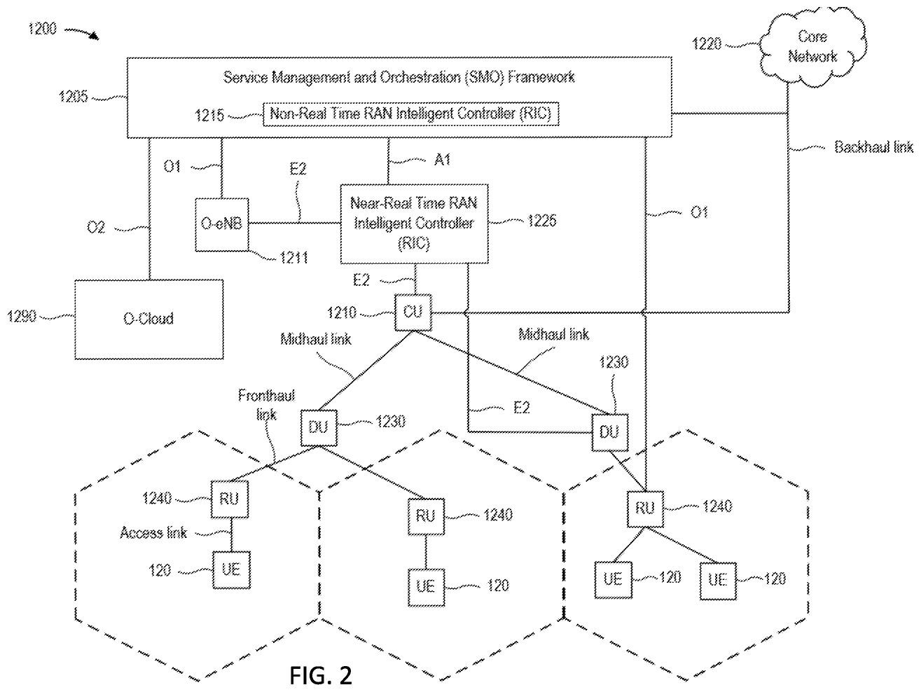

FIG. 2 shows a diagram illustrating an example disaggregated base station 1200 architecture. The disaggregated base station 1200 architecture may include one or more central units (CUs) 1210 that can communicate directly with a core network 1220 via a backhaul link, or indirectly with the core network 1220 through one or more disaggregated base station units (such as a Near-Real Time (Near-RT) RAN Intelligent Controller (RIC) 1225 via an E2 link, or a Non-Real Time (Non-RT) RIC 1215 associated with a Service Management and Orchestration (SMO) Framework 1205, or both). A CU 1210 may communicate with one or more distributed units (DUs) 1230 via respective midhaul links, such as an F1 interface. The DUs 1230 may communicate with one or more radio units (RUs) 1240 via respective fronthaul links. The RUs 1240 may communicate with respective UEs 120 via one or more radio frequency (RF) access links. In some implementations, the UE 120 may be simultaneously served by multiple RUs 1240.

Each of the units, i.e., the CUS 1210, the DUs 1230, the RUs 1240, as well as the Near-RT RICs 1225, the Non-RT RICs 1215 and the SMO Framework 1205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1210. The CU 1210 may be configured to handle user plane functionality (i.e., Central Unit-User Plane (CU-UP)), control plane functionality (i.e., Central Unit-Control Plane (CU-CP)), or a combination thereof. In some implementations, the CU 1210 can be logically split into one or more CU-UP units and one or more CU-CP units. The CU-UP unit can communicate bidirectionally with the CU-CP unit via an interface, such as the E1 interface when implemented in an O-RAN configuration. The CU 1210 can be implemented to communicate with the DU 1230, as necessary, for network control and signaling.

The DU 1230 may correspond to a logical unit that includes one or more base station functions to control the operation of one or more RUs 1240. In some aspects, the DU 1230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1230 may further host one or more low PHY layers. Each layer (or module) can be implemented with an interface configured to communicate signals with other layers (and modules) hosted by the DU 1230, or with the control functions hosted by the CU 1210.

Lower-layer functionality can be implemented by one or more RUs 1240. In some deployments, an RU 1240, controlled by a DU 1230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1240 can be implemented to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable the DU(s) 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements which may be managed via an operations and maintenance interface (such as an O1 interface). For virtualized network elements, the SMO Framework 1205 may be configured to interact with a cloud computing platform (such as an open cloud (O-Cloud) 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240 and Near-RT RICs 1225. In some implementations, the SMO Framework 1205 can communicate with a hardware aspect of a 4G RAN, such as an open eNB (O-eNB) 1211, via an O1 interface. Additionally, in some implementations, the SMO Framework 1205 can communicate directly with one or more RUs 1240 via an O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an A1 interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT RIC 1225.

In some implementations, to generate AI/ML models to be deployed in the Near-RT RIC 1225, the Non-RT RIC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via O1) or via creation of RAN management policies (such as A1 policies).

In some aspects, a method of wireless communication may be performed by the UE 120. The method may include monitoring a first set of physical downlink control channel (PDCCH) candidate resources for a PDCCH communication from the RU 1240, receiving, from the RU 1240, a plurality of demodulation reference signals (DMRSs) and decoding, based on a metric associated with the plurality of demodulation reference signals (DMRSs) satisfying a threshold, the PDCCH communication.

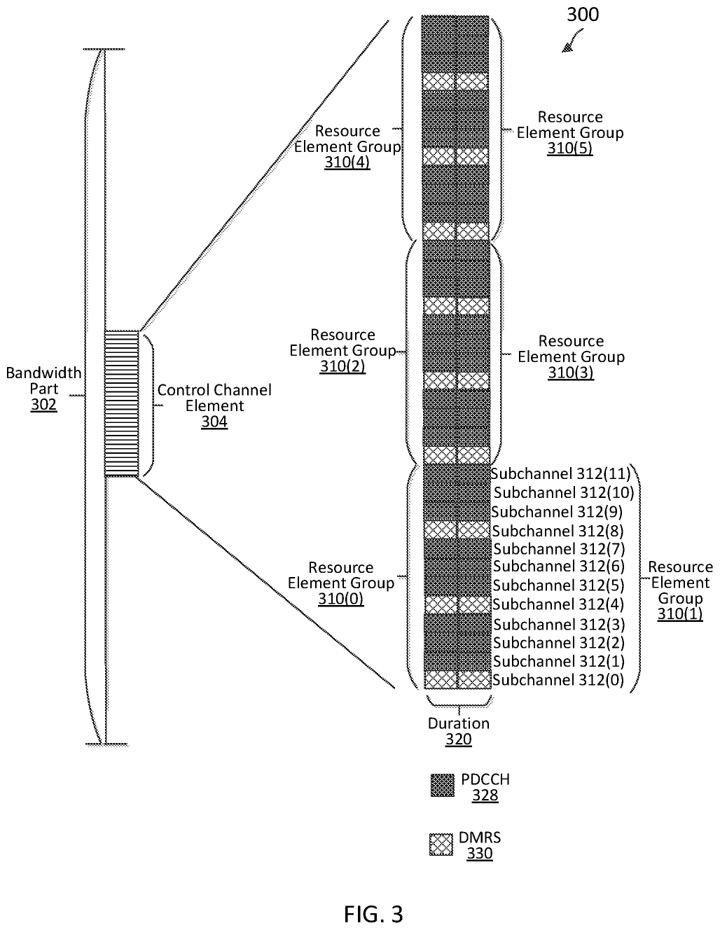

FIG. 3 illustrates resources 300 associated with a PDCCH communication according to some aspects of the present disclosure. In some aspects a UE (e.g., the UE 115, 120, or 600) may monitor a first set of physical downlink control channel (PDCCH) candidate resources 328 for a PDCCH communication from a network unit (e.g., the BS 105, the CU 1210, the DU 1230, the RU 1240, and/or network unit 700). In this regard, the UE may monitor time/frequency resources for a PDCCH communication intended for the UE. The PDDCH communication may be intended for the UE based on an identifier (e.g., a radio network temporary identifier (RNTI)) associated with the UE. A network unit (e.g., the BS 105, the CU 1210, the DU 1230, the RU 1240, and/or network unit 700) may configure the UE (e.g., configure via RRC signaling) with one or more control resource sets (CORESETs) in one or more frequency sub-bands (e.g., one or more frequency channels and/or sub-channels). A CORESET may include a set of frequency resources over a number of symbols (e.g., a number of symbols in time) indicated by a duration 320. The network unit may configure the UE with one or more search spaces (e.g., time/frequency resources 300 in the downlink resource grid that may carry the PDCCH communication intended for the UE) for PDCCH 328 monitoring based on the one or more CORESETs. The duration 320 of the CORESET may include any suitable number (e.g., 1, 2, 3, 4, or more) of symbols. In the example of FIG. 3, the duration 320 may include 2 symbols. The UE may perform blind decoding in the search spaces to search for DCI information from the network unit. For example, the network unit may configure the UE with the frequency sub-bands, the CORESETs, and/or the PDCCH search spaces as control channel elements 304 and/or resource element groups 310 via RRC configurations. Accordingly, the UE may perform blind decoding in one or more search spaces that may be configured via RRC signaling. The network unit (e.g., the BS 105, the CU 1210, the DU 1230, the RU 1240, or the RU 1240) may transmit a plurality of PDCCH communications (e.g., a first set of PDCCH communications) intended for multiple UEs in the time/frequency resources 300 associated with the one or more search spaces configured for the UE. The plurality of PDCCH communications 328 transmitted by the network unit may include the first PDCCH intended for the UE.

The number of PDCCH candidate resources 328 searched by the UE may be based on an aggregation level (AL). The AL may indicate the number of control channel elements (CCEs) 304 within a bandwidth part 302 used for each PDCCH candidate 328. Each CCE 304 may include six resource elements groups (REGs) 310(0) . . . 310(5) or other suitable number of REGs 310, where a REG 310 can be one physical RB in one symbol. The AL may be based on a quality of the channel. For example, if the UE is located near the network unit, the AL may be lower as compared to when the UE is farther from the network unit. The higher the AL, the more redundancy and more frequency diversity can be provided by the PDCCH transmission, and thus the more robust the PDCCH transmission may be.

The UE may attempt to blind decode a cyclic redundancy check (CRC) within the search spaces with an RNTI value (such as C-RNTI for UE-specific search spaces, or other RNTI types for common search spaces) using a trial-and-error approach of resource locations and parameters. This blind decoding method may consume finite resources associated with the UE. Such finite resources may be limited depending on per slot capabilities of the UE such as the number of PDCCH 328 blind decoding candidates per slot and/or the number of CCEs 304 that the UE may monitor per slot. Monitoring all of the PDCCH 328 candidate resources for the PDCCH 328 communication intended for the UE may consume more power and/or computing resources associated with the UE as compared to monitoring a subset of the PDCCH 328 candidate resources. In accordance with the present disclosure, the UE may select a subset of the PDCCH 328 candidate resources for monitoring in order to reduce power and/or computing resources associated with the UE.

In some aspects, a UE (e.g., the UE 115, 120, or 600) may receive a plurality of demodulation reference signals (DMRSs) 330 from the network unit. In this regard, the plurality of DMRSs 330 may assist the UE in decoding information from the PDCCH 328 communication. The network unit may include the plurality of DMRSs 330 in the time/frequency resources 300 associated with the one or more search spaces to assist the UE in channel estimation and/or PDCCH 328 decoding.

In some aspects, upon receiving one or more candidate PDCCH 328 communications from the network unit in the one or more search spaces, the UE may estimate a channel response from the associated DMRSs 330, perform demodulation of the candidate PDCCH 328 communications based on an estimated channel response, and/or decode data from the candidate PDCCH 328 communications. In some aspects, the UE may select a subset of the PDCCH 328 candidate resources for decoding based on the channel response and/or other channel measurements. In some instances, the UE may determine a metric based on the channel response and/or channel measurements associated with the plurality of DMRSs 330. The UE may utilize the metric to determine whether to decode a particular candidate PDCCH 328 communication of the one or more candidate PDCCH 328 communications.

In some aspects, a UE (e.g., the UE 115, 120, or 600) may decode the PDCCH communication (e.g., a PDCCH communication received based on the monitoring of the time/frequency resources 300). The UE may decode the PDCCH 328 communication based on a metric associated with the plurality of DMRSs 330 satisfying a threshold. In some aspects, the UE may select a second set of PDCCH 328 candidate resources for decoding from the first set of PDCCH 328 candidate resources based on the metric. The UE may decode the PDCCH 328 communication (e.g., the candidate PDCCH 328 communication intended for the UE) from the second set of PDCCH 328 candidate resources. The second set of PDCCH 328 candidate resources may have a higher probability of including a PDCCH 328 communication intended for the UE than the PDCCH 328 candidate resources that are not included in the second set of PDCCH 328 candidate resources. By attempting to decode the smaller second set of PDCCH 328 candidate resources rather than the larger first set of PDCCH 328 candidate resources, the UE may conserve power and/or computing resources.

In some aspects, the UE may determine the metric based on one or more channel responses and/or channel measurements associated with the plurality of DMRSs 330. For example, in some instances the metric may be based on a ratio of a summation of a first set of channel coefficients associated with the plurality of DMRSs 330 to a summation of a second set of channel coefficients associated with the plurality of DMRSs 330. Additionally or alternatively, the UE may determine the metric based on a ratio of an absolute value of a summation of channel coefficients associated with the plurality of DMRSs 330 to an absolute value of a summation of a subset (e.g., a second set) of DMRSs 330 of the plurality of DMRS 330. Additionally or alternatively, the UE may determine the metric based on a ratio of a summation of a first set of values associated with an addition of channel coefficients of adjacent DMRSs 330 (e.g., DMRSs that are carried via adjacent DMRS frequency subchannels 312) to a summation of a second set of values associated with a difference in channel coefficients of the adjacent DMRSs 330. DMRSs 330 that are carried via adjacent DMRS frequency subchannels 312 may be separated by a number of frequency subchannels 312. In some aspects, the frequency subchannels 312 of the adjacent DMRSs 330 may be separated by a number (e.g., 1, 2, 3, 4, 5, or more) of frequency subchannels 312. For example, the adjacent DMRSs 330 may be separated by 4 frequency subchannels 312. As shown in FIG. 3, resource element group 310(1) may include 12 frequency subchannels 312(0) . . . 312(11). Subchannel 312(0) may carry a DMRS 330 while adjacent subchannels 312(4) and 312(8) are each separated by 4 frequency subchannels 312. The channel coefficient may be associated with the communication channel between the UE and the network unit. The channel coefficient may represent an estimation of the channel quality. For example, the channel coefficient may be a ratio of the DMRS 330 received by the UE to the DMRS 330 (e.g., a known reference signal) transmitted by the network unit to the UE.

In some aspects, the UE may determine the metric based on equation (1) below:

$$α = \frac{{\sum }_{i = 1}^{N - 1} {‖ h [ i ] + h [ i - n ] ‖}^{2}}{{\sum }_{i = 1}^{N - 1} {‖ h [ i ] - h [ i - n ] ‖}^{2}} \qquad ( 1 )$$

In equation (1), a may represent the metric used to select the second set of PDCCH 328 candidate resources from the first set of PDCCH 328 candidate resources. h[i] may represent the channel coefficient associated with the DMRS 330 having the index i and h[i-n] may represent the channel coefficient associated with the DMRS 330 having the index i-n. Further, h[i] and h[i-n] may represent DMRSs 330 that are carried via adjacent frequency subchannels 312, where n represents the number of frequency subchannels 312 separating adjacent DMRSs 330. In some aspects, the frequency subchannels 312 of the adjacent DMRSs 330 may be separated by a number (e.g., 1, 2, 3, 4, 5, or more) of frequency subchannels. For example, as shown in FIG. 3, the adjacent DMRSs 330 may be separated by 4 frequency subchannels 312 (e.g., n=4). The resource elements in frequency subchannels 312 between the adjacent DMRSs 330 may be the PDCCH 328 candidate resources (e.g., the DMRS 330 resource elements may be interlaced in the frequency domain with the PDCCH 328 candidate resource elements). For example, the plurality of DMRSs 330 may be associated with frequency subchannels 312(0), 312(4), and 312(8), etc. The PDCCH 328 candidate resources may be associated with frequency subchannels 312(1), 312(2), 312(3), 312(5), 312(6), 312(7), 312(9), 312(10), and 312(11), etc.

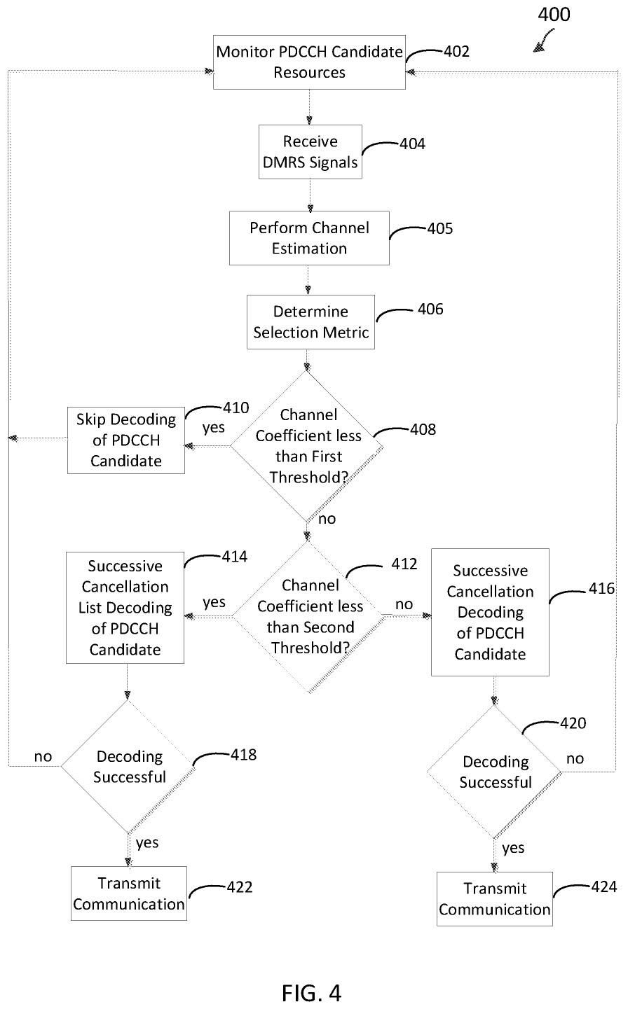

FIG. 4 is a flow diagram of a wireless communication method 400 according to some aspects of the present disclosure. Actions of the communication method 400 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the PDCCH decoding module 608, the transceiver 610, the modem 612, and the one or more antennas 616, to execute aspects of method 400.

At action 402, a UE (e.g., the UE 115, UE 120, or UE 600) may monitor PDCCH candidate resources for a PDCCH communication intended for the UE from a network unit. In this regard, the UE may monitor time/frequency resources for a PDCCH communication intended for the UE. The PDDCH communication may be intended for the UE based on an identifier (e.g., a radio network temporary identifier (RNTI)) associated with the UE. A network unit (e.g., the BS 105, the CU 1210, the DU 1230, the RU 1240, and/or network unit 700) may configure the UE (e.g., configure via RRC signaling) with one or more control resource sets (CORESETs) in one or more frequency sub-bands (e.g., one or more frequency channels and/or sub-channels). A CORESET may include a set of frequency resources over a number of symbols in time. The network unit may configure the UE with one or more search spaces (e.g., time/frequency resource in the downlink resource grid that may carry the PDCCH communication intended for the UE) for PDCCH monitoring based on the one or more CORESETs. The UE may perform blind decoding in the search spaces to search for DCI information from the network unit. For example, the network unit may configure the UE with the frequency sub-bands, the CORESETs, and/or the PDCCH search spaces via RRC configurations. Accordingly, the UE may perform blind decoding in one or more search spaces that may be configured via RRC signaling. The network unit (e.g., the BS 105, the CU 1210, the DU 1230, the RU 1240, or the RU 1240) may transmit a plurality of PDCCH communications (e.g., a first set of PDCCH communications) intended for multiple UEs in the time/frequency resources associated with the one or more search spaces configured for the UE. The plurality of PDCCH communications transmitted by the network unit may include the first PDCCH intended for the UE.

At action 404, the UE may receive DMRSs. In this regard, the UE may receive a plurality of DMRSs from the network unit. The plurality of DMRSs may assist the UE in decoding information from the PDCCH communication. The network unit may include the plurality of DMRSs in the time/frequency resources associated with the one or more search spaces to assist the UE in channel estimation and/or PDCCH decoding.

At action 406, the UE may perform channel estimation on the DMRSs. Upon receiving one or more candidate PDCCH communications from the network unit in the one or more search spaces, the UE may estimate a channel response from the associated DMRSs, perform demodulation of the candidate PDCCH communications based on an estimated channel response, and/or decode data from the candidate PDCCH communications. In some aspects, the UE may select a subset of the PDCCH candidate resources for decoding based on the channel response and/or other channel measurements.

At action 408, the UE may determine a selection metric to select a second smaller set of PDCCH candidates from the larger first set of PDCCH candidates for decoding. In some aspects, the UE may determine the second set of PDCCH candidate resources based on the metric associated with the DMRSs satisfying a threshold. In this regard, the threshold may be based on a power capacity of the UE, a power consumption of the UE, and/or computing/memory resources associated with the UE. A PDCCH candidate resource of the first set of PDCCH candidate resources may be included in the second set of PDCCH candidate resources based on the metric associated with the DMRSs adjacent to the PDCCH candidate resource elements satisfying the threshold. The UE may reduce the set of PDCCH candidate resources for decoding in order to reduce power consumption and computing resources associated with the UE. In some aspects, the UE may perform decoding on the second set of PDCCH candidate resources using any suitable method. For example, the UE may perform successive cancellation list decoding and/or successive cancellation decoding on the second set of PDCCH candidate resources. In this regard, the UE may utilize multiple thresholds. The UE may select a particular decoding technique based on the value of the metric relative to the multiple thresholds. For example, if the metric is less than (or equal to) a first threshold, the UE may skip decoding; if the metric is greater than (or equal to) the first threshold and less than (or equal to) a second threshold, the UE may utilize successive cancellation list decoding; and if the metric is greater than (or equal to) the second threshold, the UE may utilize successive cancellation decoding. Other combinations of thresholds and/or decoding technique may be utilized in accordance with the present disclosure.

In some instances, the UE may determine one or more thresholds for the metric. For example, the UE may determine a first threshold of the metric and a second threshold of the metric. The second threshold may be greater in value than the first metric. In some aspects, the UE may determine the first threshold and/or the second threshold based on simulations that predict the probability of correctly decoding the PDCCH communication. In some aspects, the first threshold and/or the second threshold may be preprogrammed and/or stored in the UE. In some aspects, the UE may receive an indicator indicating the values of the first threshold and/or the second threshold from a network unit (e.g., BS 105, the CU 1210, the DU 1230, the RU 1240, and/or network unit 700). In this regard, the UE may receive the indicator indicating the values of the first threshold and/or the second threshold from the network unit via radio resource control (RRC) messaging, downlink control information (DCI), a medium access control-control element (MAC-CE), or other suitable communication.

At action 408, the UE may compare the channel coefficient to a first threshold. If the channel coefficient associated with the DMRS is less than the metric (e.g., a), the PDCCH candidate in resources adjacent to the DMRS resources may be excluded from the second set of PDCCH candidate resources.

At 410, the UE may skip decoding of the PDCCH candidate based on the PDCCH candidate in resources adjacent to the DMRS resources being excluded from the second set of PDCCH candidate resources.

At action 412, the UE may compare the channel coefficient to a second threshold. If a channel coefficient associated with a DMRS is greater than or equal to the first threshold but less than the second threshold, the PDCCH candidate in resources adjacent to the DMRS resources may be decoded using successive cancellation list decoding or other suitable decoding method. If a channel coefficient associated with a DMRS is greater than or equal to the second threshold, the PDCCH candidate in resources adjacent to the DMRS resources may be decoded using successive cancellation decoding or other suitable decoding method.

At action 414, the UE may perform successive cancellation list decoding of the PDCCH candidate. The UE may successfully decode the PDCCH communication intended for the UE. In this regard, the UE may identify the PDCCH communication intended for it by decoding the second set of PDCCH candidate resources. The UE may use its radio network temporary identifier (RNTI) to decode the second set of PDCCH candidate resources. The RNTI may be used to demask the PDCCH communication from the second set of candidate PDCCH communications using the CRC. If no CRC error is detected, then the UE may determine that the candidate PDCCH communication carries the PDCCH communication intended for the UE. After successfully decoding the PDCCH communication, the UE may decode the downlink control information (DCI) carried via the PDCCH communication to obtain information about a physical downlink shared channel (PDSCH) resource allocation and/or a physical uplink shared channel (PUSCH) resource allocation.

At action 416, the UE may perform successive cancellation decoding of the PDCCH candidate. The UE may successfully decode the PDCCH communication intended for the UE. In this regard, the UE may identify the PDCCH communication intended for it by decoding the second set of PDCCH candidate resources. The UE may use its radio network temporary identifier (RNTI) to decode the second set of PDCCH candidate resources. The RNTI may be used to demask the PDCCH communication from the second set of candidate PDCCH communications using the CRC. If no CRC error is detected, then the UE may determine that the candidate PDCCH communication carries the PDCCH communication intended for the UE. After successfully decoding the PDCCH communication, the UE may decode the downlink control information (DCI) carried via the PDCCH communication to obtain information about a physical downlink shared channel (PDSCH) resource allocation and/or a physical uplink shared channel (PUSCH) resource allocation

At action 418, if the PDCCH candidate decoding is successful, the method may proceed to action 422. If the decoding is unsuccessful, the method may proceed to action 402 to repeat the process on other PDCCH candidate resources.

At action 420, the if the decoding is successful, the method may proceed to action 424. If the decoding is unsuccessful, the method may proceed to action 402 to repeat the process on other PDCCH candidate resources.

At action 422, the UE may transmit a communication (e.g., a transport block) to the network unit based on the PUSCH resource allocation.

At action 424, the UE may transmit a communication (e.g., a transport block) to the network unit based on the PUSCH resource allocation.

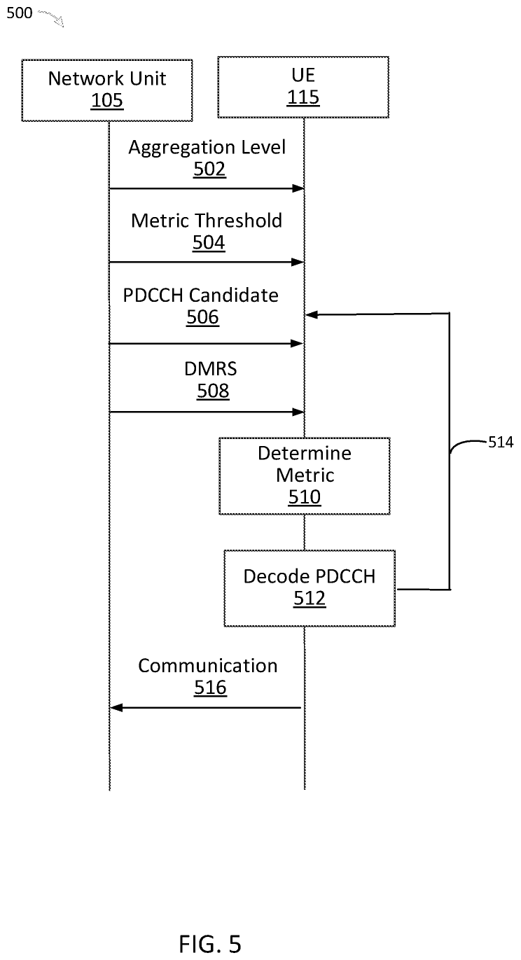

FIG. 5 is a signaling diagram of a communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the PDCCH decoding module 608, the transceiver 610, the modem 612, and the one or more antennas 616, to execute aspects of method 500.

At action 502, the network unit 105 may transmit an indicator indicating an aggregation level to the UE 115. In this regard, the network unit 105 may transmit the indicator indicating the aggregation level to the UE 115 via RRC signaling. The AL may indicate the number of control channel elements (CCEs) used for each PDCCH candidate. Each CCE may include six resource elements groups (REGs) or other suitable number of REGs, where a REG can be one physical RB in one symbol. The AL may be based on a quality of the channel. For example, if the UE is located near the network unit, the AL may be lower as compared to when the UE is farther from the network unit. The higher the AL, the more redundancy and more frequency diversity can be provided by the PDCCH transmission, and thus the more robust the PDCCH transmission may be.

At action 504, the network unit 105 may transmit an indicator indicating a threshold associated with selecting a smaller set of PDCCH candidate resources for decoding from a larger set of PDCCH candidate resources. Additionally or alternatively, the UE 115 may determine the threshold. Additionally or alternatively, the threshold may be preconfigured and stored in the UE.

At action 506, the network unit 105 may transmit PDCCH candidates in PDCCH candidate resources. The network unit 105 may configure the UE 115 via RRC signaling with one or more control resource sets (CORESETs) in one or more frequency sub-bands (e.g., one or more frequency channels and/or sub-channels). A CORESET may include a set of PDCCH candidate resources in frequency resources over a number of symbols in time. The network unit may configure the UE with one or more search spaces (e.g., time/frequency resource in the downlink resource grid that may carry the PDCCH communication intended for the UE) for PDCCH monitoring based on the one or more CORESETs.

At action 508, the network unit 105 may transmit a plurality of DMRSs to the UE 115. In this regard, the UE may receive a plurality of DMRSs from the network unit 105. The plurality of DMRSs may assist the UE 115 in decoding information from the PDCCH candidate resources received at action 506. The network unit 105 may include the plurality of DMRSs in the time/frequency resources associated with the one or more search spaces to assist the UE 115 in channel estimation and/or PDCCH decoding. The UE 115 may perform channel estimation on the DMRSs. Upon receiving one or more candidate PDCCH communications from the network unit 105 in the one or more search spaces, the UE 115 may estimate a channel response from the associated DMRSs.

At action 510, the UE 115 may determine a metric associated with the channel responses of the DMRSs received at action 508. The UE 115 may determine the metric based on equation (1).

At action 512, the UE 115 may perform demodulation of the candidate PDCCH communications based on an estimated channel response, and/or decode data from the candidate PDCCH communications. In some aspects, the UE may select a subset of the PDCCH candidate resources for decoding based on the channel response and/or other channel measurements. In some instances, the UE may determine a metric based on the channel response and/or channel measurements associated with the plurality of DMRSs. The UE may utilize the metric to determine whether to decode a particular candidate PDCCH communication of the one or more candidate PDCCH communications.

At action 514, if the decoding by the UE 115 is not successful, the method 500 will return to action 506 to determine whether to decode another PDCCH candidate resources based on the metric thresholds.

At action 516, the UE 115 may transmit a communication to the network unit 105 based on successful PDCCH candidate decoding at action 512.

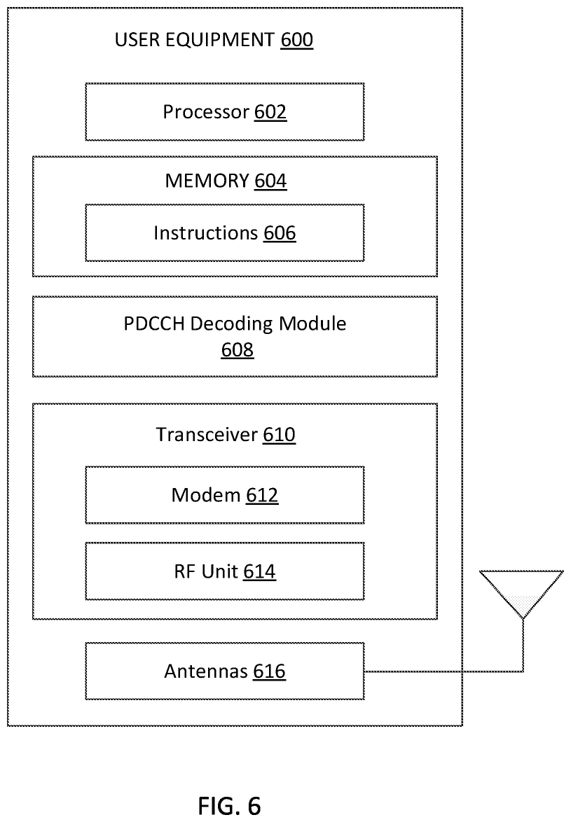

FIG. 6 is a block diagram of an exemplary UE 600 according to some aspects of the present disclosure. The UE 600 may be the UE 115 or the UE 120 in the network 100, 200, or 250 as discussed above. As shown, the UE 600 may include a processor 602, a memory 604, a PDCCH decoding module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PDCCH decoding module 608 may be implemented via hardware, software, or combinations thereof. For example, the PDCCH decoding module 608 may be implemented as a processor, circuit, and/or instructions 606 stored in the memory 604 and executed by the processor 602. In some aspects, the PDCCH decoding module 608 may be used to monitor a first set of physical downlink control channel (PDCCH) candidate resources for a PDCCH communication from the network unit 700 or the BS 105, receive, from the network unit 700 or the BS 105, a plurality of demodulation reference signals (DMRSs) and decode, based on a metric associated with the plurality of demodulation reference signals (DMRSs) satisfying a threshold, the PDCCH communication.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

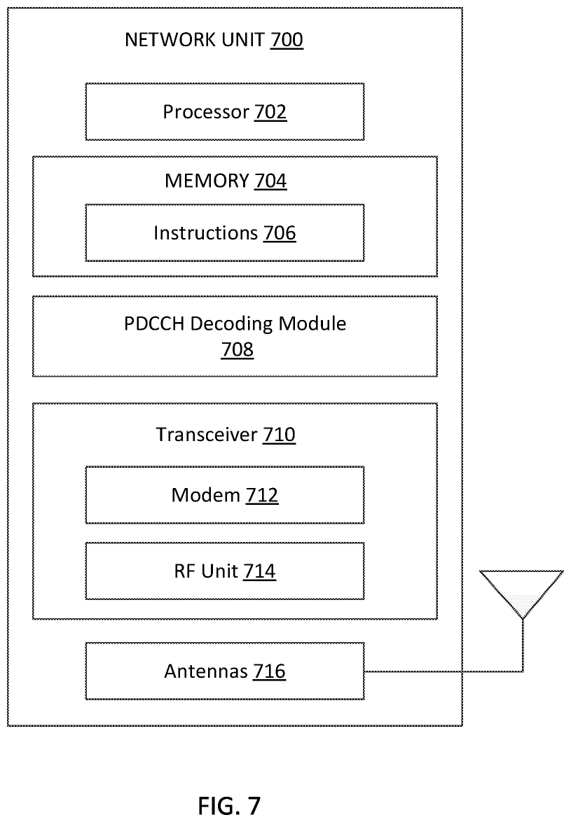

FIG. 7 is a block diagram of an exemplary network unit 700 according to some aspects of the present disclosure. The network unit 700 may be a BS 105, the CU 1210, the DU 1230, or the RU 1240, as discussed above. As shown, the network unit 700 may include a processor 702, a memory 704, a PDCCH decoding module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The PDCCH decoding module 708 may be implemented via hardware, software, or combinations thereof. For example, the PDCCH decoding module 708 may be implemented as a processor, circuit, and/or instructions 706 stored in the memory 704 and executed by the processor 702.

In some aspects, the PDCCH decoding module 708 may implement the aspects of FIGS. 2-5 and 8-9. For example, the PDCCH decoding module 708 may transmit, to a UE (e.g., UE 115, UE 120, or UE 600), an indication of a set of physical downlink control channel (PDCCH) candidate resources, transmit, to the UE, a plurality of demodulation reference signals (DMRSs), and receive, from the UE based on a metric associated with the plurality of DMRSs, a communication.

Additionally or alternatively, the PDCCH decoding module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

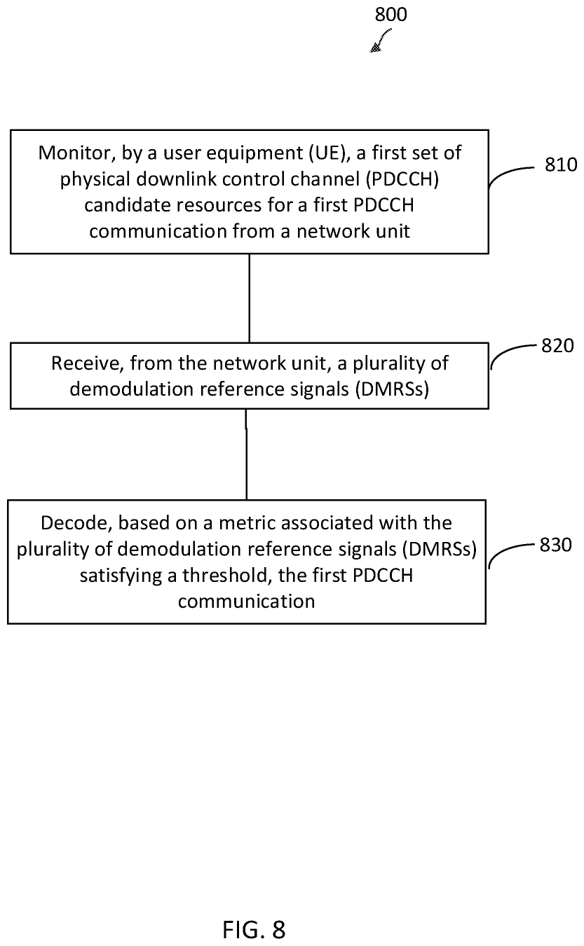

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 800. The method 800 may employ similar mechanisms as in the networks 100 and 200 and the aspects and actions described with respect to FIGS. 2-5. For example, a wireless communication device, such as the UE 115, UE 120, or UE 600, may utilize one or more components, such as such as the processor 602, the memory 604, the PDDCH decoding module 608, the transceiver 610, the modem 612, and the one or more antennas 616, to execute aspects of the method 800. As illustrated, the method 800 includes a number of enumerated aspects, but the method 800 may include additional aspects before, after, and in between the enumerated aspects. In some aspects, one or more of the enumerated aspects may be omitted or performed in a different order.

At action 810, the method 800 includes a UE (e.g., the UE 115, 120, or 600) monitoring a first set of physical downlink control channel (PDCCH) candidate resources for a PDCCH communication from a network unit. In this regard, the UE may monitor time/frequency resources for a PDCCH communication intended for the UE. The PDDCH communication may be intended for the UE based on an identifier (e.g., a radio network temporary identifier (RNTI)) associated with the UE. A network unit (e.g., the BS 105, the CU 1210, the DU 1230, the RU 1240, and/or network unit 700) may configure the UE (e.g., configure via RRC signaling) with one or more control resource sets (CORESETs) in one or more frequency sub-bands (e.g., one or more frequency channels and/or sub-channels). A CORESET may include a set of frequency resources over a number of symbols in time. The network unit may configure the UE with one or more search spaces (e.g., time/frequency resource in the downlink resource grid that may carry the PDCCH communication intended for the UE) for PDCCH monitoring based on the one or more CORESETs. The UE may perform blind decoding in the search spaces to search for DCI information from the network unit. For example, the network unit may configure the UE with the frequency sub-bands, the CORESETs, and/or the PDCCH search spaces via RRC configurations. Accordingly, the UE may perform blind decoding in one or more search spaces that may be configured via RRC signaling. The network unit (e.g., the BS 105, the CU 1210, the DU 1230, the RU 1240, or the RU 1240) may transmit a plurality of PDCCH communications (e.g., a first set of PDCCH communications) intended for multiple UEs in the time/frequency resources associated with the one or more search spaces configured for the UE. The plurality of PDCCH communications transmitted by the network unit may include the first PDCCH intended for the UE.

The number of PDCCH candidate resources searched by the UE may be based on an aggregation level (AL). The AL may indicate the number of control channel elements (CCEs) used for each PDCCH candidate. Each CCE may include six resource elements groups (REGs) or other suitable number of REGs, where a REG can be one physical RB in one symbol. The AL may be based on a quality of the channel. For example, if the UE is located near the network unit, the AL may be lower as compared to when the UE is farther from the network unit. The higher the AL, the more redundancy and more frequency diversity can be provided by the PDCCH transmission, and thus the more robust the PDCCH transmission may be.

The UE may attempt to blind decode a cyclic redundancy check (CRC) within the search spaces with an RNTI value (such as C-RNTI for UE-specific search spaces, or other RNTI types for common search spaces) using a trial-and-error approach of resource locations and parameters. This blind decoding method may consume finite resources associated with the UE. Such finite resources may be limited depending on per slot capabilities of the UE such as the number of PDCCH blind decoding candidates per slot and/or the number of CCEs that the UE may monitor per slot. Monitoring all of the PDCCH candidate resources for the PDCCH communication intended for the UE may consume more power and/or computing resources associated with the UE as compared to monitoring a subset of the PDCCH candidate resources. As described with reference to action 830 below, in accordance with the present disclosure the UE may select a subset of the PDCCH candidate resources for monitoring in order to reduce power and/or computing resources associated with the UE.

At action 820, the method 800 includes a UE (e.g., the UE 115, 120, or 600) receiving a plurality of demodulation reference signals (DMRSs) from the network unit. In this regard, the plurality of DMRSs may assist the UE in decoding information from the PDCCH communication. The network unit may include the plurality of DMRSs in the time/frequency resources associated with the one or more search spaces to assist the UE in channel estimation and/or PDCCH decoding.

Upon receiving one or more candidate PDCCH communications from the network unit in the one or more search spaces, the UE may estimate a channel response from the associated DMRSs, perform demodulation of the candidate PDCCH communications based on an estimated channel response, and/or decode data from the candidate PDCCH communications. In some aspects, the UE may select a subset of the PDCCH candidate resources for decoding based on the channel response and/or other channel measurements. In some instances, the UE may determine a metric based on the channel response and/or channel measurements associated with the plurality of DMRSs. The UE may utilize the metric to determine whether to decode a particular candidate PDCCH communication of the one or more candidate PDCCH communications, as described at action 830.

At action 830, the method 800 includes a UE (e.g., the UE 115, 120, or 600) decoding the PDCCH communication (e.g., a PDCCH communication received based on the monitoring at action 810). The UE may decode the PDCCH communication based on a metric associated with the plurality of DMRSs satisfying a threshold. In some aspects, the UE may select a second set of PDCCH candidate resources for decoding from the first set of PDCCH candidate resources based on the metric. The UE may decode the PDCCH communication (e.g., the candidate PDCCH communication intended for the UE) from the second set of PDCCH candidate resources. The second set of PDCCH candidate resources may have a higher probability of including a PDCCH communication intended for the UE than the PDCCH candidate resources that are not included in the second set of PDCCH candidate resources. By attempting to decode the smaller second set of PDCCH candidate resources rather than the larger first set of PDCCH candidate resources, the UE may conserve power and/or computing resources.

In some aspects, the UE may determine the metric based on one or more channel responses and/or channel measurements associated with the plurality of DMRSs. For example, in some instances the metric may be based on a ratio of a summation of a first set of channel coefficients associated with the plurality of DMRSs to a summation of a second set of channel coefficients associated with the plurality of DMRSs. Additionally or alternatively, the UE may determine the metric based on a ratio of an absolute value of a summation of channel coefficients associated with the plurality of DMRSs to an absolute value of a summation of a subset (e.g., a second set) of DMRSs of the plurality of DMRS. Additionally or alternatively, the UE may determine the metric based on a ratio of a summation of a first set of values associated with an addition of channel coefficients of adjacent DMRSs (e.g., DMRSs that are carried via adjacent DMRS frequency subchannels) to a summation of a second set of values associated with a difference in channel coefficients of the adjacent DMRSs. DMRSs that are carried via adjacent DMRS frequency subchannels may be separated by a number of frequency subchannels. In some aspects, the frequency subchannels of the adjacent DMRSs may be separated by a number (e.g., 1, 2, 3, 4, 5, or more) of frequency subchannels. For example, the adjacent DMRSs may be separated by 4 frequency subchannels. The channel coefficient may be associated with the communication channel between the UE and the network unit. The channel coefficient may represent an estimation of the channel quality. For example, the channel coefficient may be a ratio of the DMRS received by the UE to the DMRS (e.g., a known reference signal) transmitted by the network unit to the UE.

In some aspects, the UE may determine the metric based on equation (1) below:

$$α = \frac{{\sum }_{i = 1}^{N - 1} {‖ h [ i ] + h [ i - n ] ‖}^{2}}{{\sum }_{i = 1}^{N - 1} {‖ h [ i ] - h [ i - n ] ‖}^{2}} \qquad ( 1 )$$

In equation (1), a may represent the metric used to select the second set of PDCCH candidate resources from the first set of PDCCH candidate resources. h[i] may represent the channel coefficient associated with the DMRS having the index i. and h[i-n] may represent the channel coefficient associated with the DMRS having the index i-n. Further, h[i] and h[i-n] may represent DMRSs that are carried via adjacent frequency subchannels, where n represents the number of frequency subchannels separating adjacent DMRSs. In some aspects, the frequency subchannels of the adjacent DMRSs may be separated by a number (e.g., 1, 2, 3, 4, 5, or more) of frequency subchannels. For example, the adjacent DMRSs may be separated by 4 frequency subchannels (e.g., n=4). The resource elements in frequency subchannels between the adjacent DMRSs may be the PDCCH candidate resources (e.g., the DMRS resource elements may be interlaced in the frequency domain with the PDCCH candidate resource elements). For example, the plurality of DMRSs may be associated with frequency subchannels having resource indexes i-0, i-4, i-8, i-12, etc. The PDCCH candidate resources may be associated with frequency subchannels having resource indexes i-1, i-2, i-3, i-5, i-6, i-7, i-9, i-10, i-11, etc.

In some aspects, the UE may determine the second set of PDCCH candidate resources based on the metric associated with the DMRSs satisfying a threshold. In this regard, the threshold may be based on a power capacity of the UE, a power consumption of the UE, and/or computing/memory resources associated with the UE. A PDCCH candidate resource of the first set of PDCCH candidate resources may be included in the second set of PDCCH candidate resources based on the metric associated with the DMRSs adjacent to the PDCCH candidate resource elements satisfying the threshold. For example, if a channel coefficient associated with a DMRS is greater than or equal to the metric (e.g., a), the PDCCH candidate in resources adjacent to the DMRS resources may be included in the second set of PDCCH candidate resources. Conversely, if the channel coefficient associated with the DMRS is less than the metric (e.g., a), the PDCCH candidate in resources adjacent to the DMRS resources may be excluded from the second set of PDCCH candidate resources. The UE may perform decoding on the PDCCH candidate resources in the second set of PDCCH candidate resources and exclude the PDCCH candidate resources from decoding that are not in the second set of PDCCH candidate resources. In this way, the UE may reduce the set of PDCCH candidate resources for decoding in order to reduce power consumption and computing resources associated with the UE.

In some aspects, the UE may perform decoding on the second set of PDCCH candidate resources using any suitable method. For example, the UE may perform successive cancellation list decoding and/or successive cancellation decoding on the second set of PDCCH candidate resources. In this regard, the UE may utilize multiple thresholds. The UE may select a particular decoding technique based on the value of the metric relative to the multiple thresholds. For example, if the metric is less than (or equal to) a first threshold, the UE may skip decoding; if the metric is greater than (or equal to) the first threshold and less than (or equal to) a second threshold, the UE may utilize successive cancellation list decoding; and if the metric is greater than (or equal to) the second threshold, the UE may utilize successive cancellation decoding. Other combinations of thresholds and/or decoding technique may be utilized in accordance with the present disclosure.

In some instances, the UE may determine one or more thresholds for the metric. For example, the UE may determine a first threshold of the metric and a second threshold of the metric. The second threshold may be greater in value than the first metric. In some aspects, the UE may determine the first threshold and/or the second threshold based on simulations that predict the probability of correctly decoding the PDCCH communication. In some aspects, the first threshold and/or the second threshold may be preprogrammed and/or stored in the UE. In some aspects, the UE may receive an indicator indicating the values of the first threshold and/or the second threshold from a network unit (e.g., BS 105, the CU 1210, the DU 1230, the RU 1240, and/or network unit 700). In this regard, the UE may receive the indicator indicating the values of the first threshold and/or the second threshold from the network unit via radio resource control (RRC) messaging, downlink control information (DCI), a medium access control-control element (MAC-CE), or other suitable communication.

In some aspects, if a channel coefficient associated with a DMRS is less than the first threshold and the second threshold, the PDCCH candidate in resources adjacent to the DMRS resources may be excluded from decoding by the UE. If a channel coefficient associated with a DMRS is greater than or equal to the first threshold but less than the second threshold, the PDCCH candidate in resources adjacent to the DMRS resources may be decoded using successive cancellation list decoding or other suitable decoding method. If a channel coefficient associated with a DMRS is greater than or equal to the second threshold, the PDCCH candidate in resources adjacent to the DMRS resources may be decoded using successive cancellation decoding or other suitable decoding method. Additionally or alternatively, if a channel coefficient associated with a DMRS is greater than or equal to the first threshold but less than the second threshold, the PDCCH candidate in resources adjacent to the DMRS resources may be decoded using successive cancellation decoding or other suitable decoding method. If a channel coefficient associated with a DMRS is greater than or equal to the second threshold, the PDCCH candidate in resources adjacent to the DMRS resources may be decoded using successive cancellation list decoding or other suitable decoding method.

In some aspects, the UE may successfully decode the PDCCH communication intended for the UE. In this regard, the UE may identify the PDCCH communication intended for it by decoding the second set of PDCCH candidate resources. The UE may use its radio network temporary identifier (RNTI) to decode the second set of PDCCH candidate resources. The RNTI may be used to demask the PDCCH communication from the second set of candidate PDCCH communications using the CRC. If no CRC error is detected, then the UE may determine that the candidate PDCCH communication carries the PDCCH communication intended for the UE. After successfully decoding the PDCCH communication, the UE may decode the downlink control information (DCI) carried via the PDCCH communication to obtain information about a physical downlink shared channel (PDSCH) resource allocation and/or a physical uplink shared channel (PUSCH) resource allocation. The UE may receive a communication (e.g., a transport block) from the network unit based on the PDSCH resource allocation. The UE may transmit a communication (e.g., a transport block) to the network unit based on the PUSCH resource allocation.

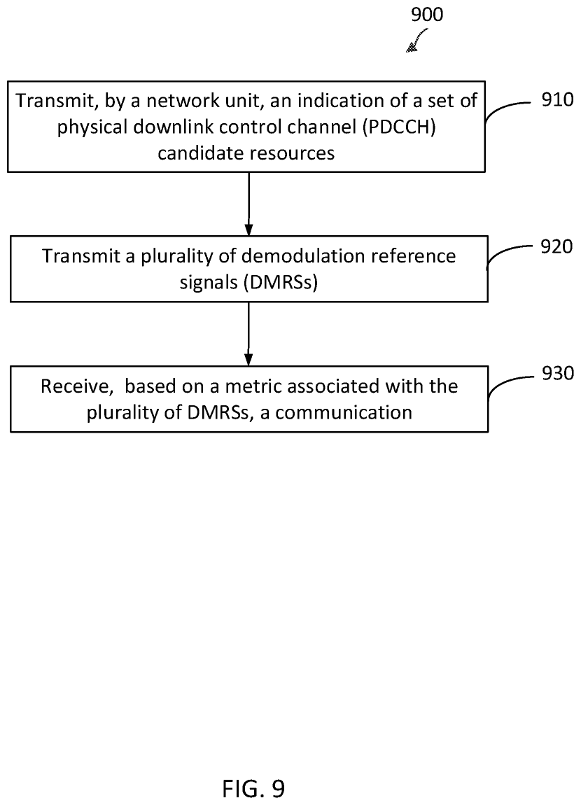

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the BS 105, the CU 1210, the DU 1230, the RU 1240, and/or network unit 700 may utilize one or more components to execute aspects of method 900. The method 900 may employ similar mechanisms as in the networks 100 and 200 and the aspects and actions described with respect to FIGS. 2-5. For example, a wireless communication device, such as the BS 105 or network unit 700, may utilize one or more components, such as such as the processor 702, the memory 704, the PDDCH decoding module 708, the transceiver 710, the modem 712, and the one or more antennas 716, to execute aspects of the method 900. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the method 900 includes a network unit (e.g., the BS 105, the CU 1210, the DU 1230, the RU 1240, and/or network unit 700) transmitting an indication of a set of physical downlink control channel (PDCCH) candidate resources to a UE (e.g., the UE 115, 120, or 600). In this regard, the UE may monitor time/frequency resources for a PDCCH communication intended for the UE. The PDDCH communication may be intended for the UE based on an identifier (e.g., a radio network temporary identifier (RNTI)) associated with the UE. A network unit (e.g., the BS 105, the CU 1210, the DU 1230, the RU 1240, and/or network unit 700) may configure the UE (e.g., configure via RRC signaling) with one or more control resource sets (CORESETs) in one or more frequency sub-bands (e.g., one or more frequency channels and/or sub-channels). A CORESET may include a set of frequency resources over a number of symbols in time. The network unit may configure the UE with one or more search spaces (e.g., time/frequency resource in the downlink resource grid that may carry the PDCCH communication intended for the UE) for PDCCH monitoring based on the one or more CORESETs. The UE may perform blind decoding in the search spaces to search for DCI information from the network unit. For example, the network unit may configure the UE with the frequency sub-bands, the CORESETs, and/or the PDCCH search spaces via RRC configurations. Accordingly, the UE may perform blind decoding in one or more search spaces that may be configured via RRC signaling. The network unit (e.g., the BS 105, the CU 1210, the DU 1230, the RU 1240, or the RU 1240) may transmit a plurality of PDCCH communications (e.g., a first set of PDCCH communications) intended for multiple UEs in the time/frequency resources associated with the one or more search spaces configured for the UE. The plurality of PDCCH communications transmitted by the network unit may include the first PDCCH intended for the UE.

The number of PDCCH candidate resources searched by the UE may be based on an aggregation level (AL). The AL may indicate the number of control channel elements (CCEs) used for each PDCCH candidate. Each CCE may include six resource elements groups (REGs) or other suitable number of REGs, where a REG can be one physical RB in one symbol. The AL may be based on a quality of the channel. For example, if the UE is located near the network unit, the AL may be lower as compared to when the UE is farther from the network unit. The higher the AL, the more redundancy and more frequency diversity can be provided by the PDCCH transmission, and thus the more robust the PDCCH transmission may be.

The UE may attempt to blind decode a cyclic redundancy check (CRC) within the search spaces with an RNTI value (such as C-RNTI for UE-specific search spaces, or other RNTI types for common search spaces) using a trial-and-error approach of resource locations and parameters. This blind decoding method may consume finite resources associated with the UE. Such finite resources may be limited depending on per slot capabilities of the UE such as the number of PDCCH blind decoding candidates per slot and/or the number of CCEs that the UE may monitor per slot. Monitoring all of the PDCCH candidate resources for the PDCCH communication intended for the UE may consume more power and/or computing resources associated with the UE as compared to monitoring a subset of the PDCCH candidate resources. In accordance with the present disclosure the UE may select a subset of the PDCCH candidate resources for monitoring in order to reduce power and/or computing resources associated with the UE.

At action 920, the method 900 includes the network unit transmitting a plurality of demodulation reference signals (DMRSs) to the UE. In this regard, the plurality of DMRSs may assist the UE in decoding information from the PDCCH communication. The network unit may include the plurality of DMRSs in the time/frequency resources associated with the one or more search spaces to assist the UE in channel estimation and/or PDCCH decoding.

Upon receiving one or more candidate PDCCH communications from the network unit in the one or more search spaces, the UE may estimate a channel response from the associated DMRSs, perform demodulation of the candidate PDCCH communications based on an estimated channel response, and/or decode data from the candidate PDCCH communications. In some aspects, the UE may select a subset of the PDCCH candidate resources for decoding based on the channel response and/or other channel measurements. In some instances, the UE may determine a metric based on the channel response and/or channel measurements associated with the plurality of DMRSs. The UE may utilize the metric to determine whether to decode a particular candidate PDCCH communication of the one or more candidate PDCCH communications.

The UE may decode the PDCCH communication based on a metric associated with the plurality of DMRSs satisfying a threshold. In some aspects, the UE may select a second set of PDCCH candidate resources for decoding from the first set of PDCCH candidate resources based on the metric. The UE may decode the PDCCH communication (e.g., the candidate PDCCH communication intended for the UE) from the second set of PDCCH candidate resources. The second set of PDCCH candidate resources may have a higher probability of including a PDCCH communication intended for the UE than the PDCCH candidate resources that are not included in the second set of PDCCH candidate resources. By attempting to decode the smaller second set of PDCCH candidate resources rather than the larger first set of PDCCH candidate resources, the UE may conserve power and/or computing resources.

In some aspects, the UE may determine the metric based on one or more channel responses and/or channel measurements associated with the plurality of DMRSs. For example, in some instances the metric may be based on a ratio of a summation of a first set of channel coefficients associated with the plurality of DMRSs to a summation of a second set of channel coefficients associated with the plurality of DMRSs. Additionally or alternatively, the UE may determine the metric based on a ratio of an absolute value of a summation of channel coefficients associated with the plurality of DMRSs to an absolute value of a summation of a subset (e.g., a second set) of DMRSs of the plurality of DMRS. Additionally or alternatively, the UE may determine the metric based on a ratio of a summation of a first set of values associated with an addition of channel coefficients of adjacent DMRSs (e.g., DMRSs that are carried via adjacent DMRS frequency subchannels) to a summation of a second set of values associated with a difference in channel coefficients of the adjacent DMRSs. DMRSs that are carried via adjacent DMRS frequency subchannels may be separated by a number of frequency subchannels. In some aspects, the frequency subchannels of the adjacent DMRSs may be separated by a number (e.g., 1, 2, 3, 4, 5, or more) of frequency subchannels. For example, the adjacent DMRSs may be separated by 4 frequency subchannels. The channel coefficient may be associated with the communication channel between the UE and the network unit. The channel coefficient may represent an estimation of the channel quality. For example, the channel coefficient may be a ratio of the DMRS received by the UE to the DMRS (e.g., a known reference signal) transmitted by the network unit to the UE.

In some aspects, the UE may determine the metric based on equation (1) below:

$$α = \frac{{\sum }_{i = 1}^{N - 1} {‖ h [ i ] + h [ i - n ] ‖}^{2}}{{\sum }_{i = 1}^{N - 1} {‖ h [ i ] - h [ i - n ] ‖}^{2}} \qquad ( 1 )$$

In equation (1), a may represent the metric used to select the second set of PDCCH candidate resources from the first set of PDCCH candidate resources. h[i] may represent the channel coefficient associated with the DMRS having the index i. and h[i-n] may represent the channel coefficient associated with the DMRS having the index i-n. Further, h[i] and h[i-n] may represent DMRSs that are carried via adjacent frequency subchannels, where n represents the number of frequency subchannels separating adjacent DMRSs. In some aspects, the frequency subchannels of the adjacent DMRSs may be separated by a number (e.g., 1, 2, 3, 4, 5, or more) of frequency subchannels. For example, the adjacent DMRSs may be separated by 4 frequency subchannels (e.g., n=4). The resource elements in frequency subchannels between the adjacent DMRSs may be the PDCCH candidate resources (e.g., the DMRS resource elements may be interlaced in the frequency domain with the PDCCH candidate resource elements). For example, the plurality of DMRSs may be associated with frequency subchannels having resource indexes i-0, i-4, i-8, i-12, etc. The PDCCH candidate resources may be associated with frequency subchannels having resource indexes i-1, i-2, i-3, i-5, i-6, i-7, i-9, i-10, i-11, etc.

In some aspects, the UE may determine the second set of PDCCH candidate resources based on the metric associated with the DMRSs satisfying a threshold. In this regard, the threshold may be based on a power capacity of the UE, a power consumption of the UE, and/or computing/memory resources associated with the UE. A PDCCH candidate resource of the first set of PDCCH candidate resources may be included in the second set of PDCCH candidate resources based on the metric associated with the DMRSs adjacent to the PDCCH candidate resource elements satisfying the threshold. For example, if a channel coefficient associated with a DMRS is greater than or equal to the metric (e.g., a), the PDCCH candidate in resources adjacent to the DMRS resources may be included in the second set of PDCCH candidate resources. Conversely, if the channel coefficient associated with the DMRS is less than the metric (e.g., a), the PDCCH candidate in resources adjacent to the DMRS resources may be excluded from the second set of PDCCH candidate resources. The UE may perform decoding on the PDCCH candidate resources in the second set of PDCCH candidate resources and exclude the PDCCH candidate resources from decoding that are not in the second set of PDCCH candidate resources. In this way, the UE may reduce the set of PDCCH candidate resources for decoding in order to reduce power consumption and computing resources associated with the UE.

In some aspects, the UE may perform decoding on the second set of PDCCH candidate resources using any suitable method. For example, the UE may perform successive cancellation list decoding and/or successive cancellation decoding on the second set of PDCCH candidate resources. In this regard, the UE may utilize multiple thresholds. The UE may select a particular decoding technique based on the value of the metric relative to the multiple thresholds. For example, if the metric is less than (or equal to) a first threshold, the UE may skip decoding; if the metric is greater than (or equal to) the first threshold and less than (or equal to) a second threshold, the UE may utilize successive cancellation list decoding; and if the metric is greater than (or equal to) the second threshold, the UE may utilize successive cancellation decoding. Other combinations of thresholds and/or decoding technique may be utilized in accordance with the present disclosure.

In some instances, the UE may determine one or more thresholds for the metric. For example, the UE may determine a first threshold of the metric and a second threshold of the metric. The second threshold may be greater in value than the first metric. In some aspects, the UE may determine the first threshold and/or the second threshold based on simulations that predict the probability of correctly decoding the PDCCH communication. In some aspects, the first threshold and/or the second threshold may be preprogrammed and/or stored in the UE. In some aspects, the UE may receive an indicator indicating the values of the first threshold and/or the second threshold from a network unit (e.g., BS 105, the CU 1210, the DU 1230, the RU 1240, and/or network unit 700). In this regard, the UE may receive the indicator indicating the values of the first threshold and/or the second threshold from the network unit via radio resource control (RRC) messaging, downlink control information (DCI), a medium access control-control element (MAC-CE), or other suitable communication.

In some aspects, if a channel coefficient associated with a DMRS is less than the first threshold and the second threshold, the PDCCH candidate in resources adjacent to the DMRS resources may be excluded from decoding by the UE. If a channel coefficient associated with a DMRS is greater than or equal to the first threshold but less than the second threshold, the PDCCH candidate in resources adjacent to the DMRS resources may be decoded using successive cancellation list decoding or other suitable decoding method. If a channel coefficient associated with a DMRS is greater than or equal to the second threshold, the PDCCH candidate in resources adjacent to the DMRS resources may be decoded using successive cancellation decoding or other suitable decoding method. Additionally or alternatively, if a channel coefficient associated with a DMRS is greater than or equal to the first threshold but less than the second threshold, the PDCCH candidate in resources adjacent to the DMRS resources may be decoded using successive cancellation decoding or other suitable decoding method. If a channel coefficient associated with a DMRS is greater than or equal to the second threshold, the PDCCH candidate in resources adjacent to the DMRS resources may be decoded using successive cancellation list decoding or other suitable decoding method.

At action 930, the method 900 includes the network unit receiving a communication from the UE based on the metric associated with the plurality of DMRSs. In some aspects, the UE may successfully decode the PDCCH communication intended for the UE. In this regard, the UE may identify the PDCCH communication intended for it by decoding the second set of PDCCH candidate resources. The UE may use its radio network temporary identifier (RNTI) to decode the second set of PDCCH candidate resources. The RNTI may be used to demask the PDCCH communication from the second set of candidate PDCCH communications using the CRC. If no CRC error is detected, then the UE may determine that the candidate PDCCH communication carries the PDCCH communication intended for the UE. After successfully decoding the PDCCH communication, the UE may decode the downlink control information (DCI) carried via the PDCCH communication to obtain information about a physical downlink shared channel (PDSCH) resource allocation and/or a physical uplink shared channel (PUSCH) resource allocation. The UE may receive a communication (e.g., a transport block) from the network unit based on the PDSCH resource allocation. The UE may transmit a communication (e.g., a transport block) to the network unit based on the PUSCH resource allocation.

Further aspects of the present disclosure include the following:

Aspect 1 includes a method of wireless communication performed by a user equipment (UE), the method comprising monitoring a first set of physical downlink control channel (PDCCH) candidate resources for a first PDCCH communication from a network unit; receiving, from the network unit, a plurality of demodulation reference signals (DMRSs); and decoding, based on a metric associated with the plurality of demodulation reference signals (DMRSs) satisfying a threshold, the first PDCCH communication.

Aspect 2 includes the method of aspect 1, further comprising selecting a second set of PDCCH candidate resources from the first set of PDCCH candidate resources based on the metric, wherein the second set of PDCCH candidate resources includes a resource associated with the first PDCCH communication.

Aspect 3 includes the method of any of aspects 1-2, wherein the metric satisfying the threshold comprises the metric being greater than the threshold; and the decoding the first PDCCH communication comprises successive cancellation decoding of the first PDCCH communication from the second set of PDCCH candidate resources based on the metric being greater than the threshold.

Aspect 4 includes the method of any of aspects 1-3, wherein the decoding the first PDCCH communication comprises at least one of decoding the first PDCCH communication using successive cancellation list decoding of the first PDCCH communication from the second set of PDCCH candidate resources based on the metric being greater than a first threshold; or decoding the first PDCCH communication using successive cancellation decoding of the first PDCCH communication from the second set of PDCCH candidate resources based on the metric being greater than a second threshold, the second threshold being greater than the first threshold.

Aspect 5 includes the method of any of aspects 1-4, wherein the metric comprises a ratio of a summation of a first set of channel coefficients associated with the plurality of DMRSs to a summation of a second set of channel coefficients associated with the plurality of DMRSs.

Aspect 6 includes the method of any of aspects 1-5, wherein the metric comprises a ratio of an absolute value of a summation of channel coefficients associated with the plurality of DMRSs to an absolute value of a summation of a subset of DMRSs of the plurality of DMRSs.

Aspect 7 includes the method of any of aspects 1-6, wherein the metric comprises a ratio of a summation of a first set of values associated with an addition of channel coefficients of adjacent DMRSs to a summation of a second set of values associated with a difference in channel coefficients of the adjacent DMRSs.

Aspect 8 includes the method of any of aspects 1-7, wherein the adjacent DMRSs are separated by four resource elements.

Aspect 9 includes the method of any of aspects 1-8, further comprising transmitting, to the network unit in response to decoding the PDCCH, a communication.

Aspect 10 includes the method of any of aspects 1-9, further comprising receiving, from the network unit via a radio resource control (RRC) message, an indicator indicating an aggregation level associated with the first set of PDCCH candidate resources, wherein a number of the plurality of DMRSs is based on the aggregation level.

Aspect 11 includes the method of any of aspects 1-10, further comprising receiving, from the network unit via a radio resource control (RRC) message, an indicator indicating the threshold.

Aspect 12 includes the method of any of aspects 1-11, wherein the threshold is based on a power capacity associated with the UE.

Aspect 13 includes a method of wireless communication performed by a network unit, comprising transmitting an indication of a set of physical downlink control channel (PDCCH) candidate resources; transmitting a plurality of demodulation reference signals (DMRSs); and receiving, based on a metric associated with the plurality of DMRSs, a communication.

Aspect 14 includes the method of aspect 13, further comprising transmitting a threshold associated with the metric, wherein the receiving the communication is based on the metric satisfying the threshold.

Aspect 15 includes the method of any of aspects 13-14, further comprising transmitting, via a radio resource control (RRC) message, an indicator indicating an aggregation level associated with the set of PDCCH candidates, wherein a number of the plurality of DMRSs is based on the aggregation level.

Aspect 16 includes a non-transitory computer-readable medium storing one or more instructions for wireless communication, the one or more instructions comprising one or more instructions that, when executed by one or more processors of a user equipment (UE), cause the UE to perform any one of aspects 1-12.

Aspect 17 includes a non-transitory computer-readable medium storing one or more instructions for wireless communication, the one or more instructions comprising one or more instructions that, when executed by one or more processors of an apparatus for wireless communications, cause the apparatus to perform any one of aspects 13-15.

Aspect 18 includes a user equipment (UE) comprising one or more means to perform any one or more of aspects 1-12.

Aspect 19 includes an apparatus for wireless communications comprising one or more means to perform any one or more of aspects 13-15.

Aspect 20 includes a user equipment (UE) comprising a memory, a transceiver and at least one processor coupled to the memory and the transceiver, wherein the UE is configured to perform any one or more of aspects 1-12.

Aspect 21 includes an apparatus for wireless communications comprising a memory, a transceiver and at least one processor coupled to the memory and the transceiver, wherein the apparatus is configured to perform any one or more of aspects 13-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a user equipment (UE), comprising:
monitoring a first set of physical downlink control channel (PDCCH) candidate resources for a PDCCH communication from a network unit;
receiving, from the network unit, a plurality of demodulation reference signals (DMRSs); and
decoding, based on a metric associated with the plurality of demodulation reference signals (DMRSs) satisfying a threshold, the PDCCH communication.

2. The method of claim 1, further comprising:
selecting a second set of PDCCH candidate resources from the first set of PDCCH candidate resources based on the metric, wherein the second set of PDCCH candidate resources includes a resource associated with the PDCCH communication.

3. The method of claim 2, wherein:
the metric satisfying the threshold comprises the metric being greater than the threshold; and
the decoding the PDCCH communication comprises successive cancellation decoding of the PDCCH communication from the second set of PDCCH candidate resources based on the metric being greater than the threshold.

4. The method of claim 2, wherein the decoding the PDCCH communication comprises at least one of:
decoding the PDCCH communication using successive cancellation list decoding of the PDCCH communication from the second set of PDCCH candidate resources based on the metric being greater than a first threshold; or
decoding the PDCCH communication using successive cancellation decoding of the PDCCH communication from the second set of PDCCH candidate resources based on the metric being greater than a second threshold, the second threshold being greater than the first threshold.

5. The method of claim 1, wherein:
the metric comprises a ratio of a summation of a first set of channel coefficients associated with the plurality of DMRSs to a summation of a second set of channel coefficients associated with the plurality of DMRSs.

6. The method of claim 1, wherein:
the metric comprises a ratio of an absolute value of a summation of channel coefficients associated with the plurality of DMRSs to an absolute value of a summation of a subset of DMRSs of the plurality of DMRSs.

7. The method of claim 1, wherein:
the metric comprises a ratio of a summation of a first set of values associated with an addition of channel coefficients of adjacent DMRSs to a summation of a second set of values associated with a difference in channel coefficients of the adjacent DMRSs.

8. The method of claim 7, wherein the adjacent DMRSs are separated by four resource elements.

9. The method of claim 1, further comprising:
transmitting, to the network unit in response to decoding the PDCCH, a communication.

10. The method of claim 1, further comprising:
receiving, from the network unit via a radio resource control (RRC) message, an indicator indicating an aggregation level associated with the first set of PDCCH candidate resources, wherein a number of the plurality of DMRSs is based on the aggregation level.

11. The method of claim 1, further comprising:
receiving, from the network unit via a radio resource control (RRC) message, an indicator indicating the threshold.

12. The method of claim 1, wherein the threshold is based on a power capacity associated with the UE.

13. A method of wireless communication performed by a network unit, comprising:
transmitting an indication of a set of physical downlink control channel (PDCCH) candidate resources;
transmitting a plurality of demodulation reference signals (DMRSs); and
receiving, based on a metric associated with the plurality of DMRSs, a communication.

14. The method of claim 13, further comprising:
transmitting a threshold associated with the metric,
wherein the receiving the communication is based on the metric satisfying the threshold.

15. The method of claim 13, further comprising:
transmitting, via a radio resource control (RRC) message, an indicator indicating an aggregation level associated with the set of PDCCH candidates, wherein a number of the plurality of DMRSs is based on the aggregation level.

16. A user equipment (UE) comprising:
a memory;
a transceiver; and
at least one processor coupled to the memory and the transceiver, wherein the UE is configured to:
monitor a first set of physical downlink control channel (PDCCH) candidate resources for a PDCCH communication from a network unit;
receive, from the network unit, a plurality of demodulation reference signals (DMRSs); and
decode, based on a metric associated with the plurality of demodulation reference signals (DMRSs) satisfying a threshold, the PDCCH communication.

17. The UE of claim 16, wherein the UE is further configured to:
select a second set of PDCCH candidate resources from the first set of PDCCH candidate resources based on the metric, wherein the second set of PDCCH candidate resources includes a resource associated with the PDCCH communication.

18. The UE of claim 17, wherein:
the metric satisfying the threshold comprises the metric being greater than the threshold; and
the UE is further configured to decode the PDCCH communication by successive cancellation decoding of the PDCCH communication from the second set of PDCCH candidate resources based on the metric being greater than the threshold.

19. The UE of claim 17, wherein the UE is further configured to at least one of:
decode the PDCCH communication using successive cancellation list decoding of the PDCCH communication from the second set of PDCCH candidate resources based on the metric being greater than a first threshold; or
decode the PDCCH communication using successive cancellation decoding of the PDCCH communication from the second set of PDCCH candidate resources based on the metric being greater than a second threshold, the second threshold being greater than the first threshold.

20. The UE of claim 16, wherein:
the metric comprises a ratio of a summation of a first set of channel coefficients associated with the plurality of DMRSs to a summation of a second set of channel coefficients associated with the plurality of DMRSs.

21. The UE of claim 16, wherein:
the metric comprises a ratio of an absolute value of a summation of channel coefficients associated with the plurality of DMRSs to an absolute value of a summation of a subset of DMRSs of the plurality of DMRSs.

22. The UE of claim 16, wherein:
the metric comprises a ratio of a summation of a first set of values associated with an addition of channel coefficients of adjacent DMRSs to a summation of a second set of values associated with a difference in channel coefficients of the adjacent DMRSs.

23. The UE of claim 22, wherein the adjacent DMRSs are separated by four resource elements.

24. The UE of claim 16, wherein the UE is further configured to:
transmit, to the network unit in response to decoding the PDCCH, a communication.

25. The UE of claim 16, wherein the UE is further configured to:
receive, from the network unit via a radio resource control (RRC) message, an indicator indicating an aggregation level associated with the first set of PDCCH candidate resources, wherein a number of the plurality of DMRSs is based on the aggregation level.

26. The UE of claim 16, wherein the UE is further configured to:
receive, from the network unit via a radio resource control (RRC) message, an indicator indicating the threshold.

27. The UE of claim 16, wherein the threshold is based on a power capacity associated with the UE.

28. An apparatus for wireless communications comprising:
a processor;
memory coupled with the processor; and
instructions stored in the memory and executable by the processor to cause the apparatus to:
transmit an indication of a set of physical downlink control channel (PDCCH) candidate resources;
transmit a plurality of demodulation reference signals (DMRSs); and
receive, based on a metric associated with the plurality of DMRSs, a communication.

29. The apparatus of claim 28, wherein the apparatus is further configured to:
transmit a threshold associated with the metric; and
receive the communication based on the metric satisfying the threshold.

30. The apparatus of claim 28, wherein the apparatus is further configured to:
transmit, via a radio resource control (RRC) message, an indicator indicating an aggregation level associated with the set of PDCCH candidates, wherein a number of the plurality of DMRSs is based on the aggregation level.
